(19) United States
(12) Patent Application Publication
(10) Pub. No.: US 2002/0171706 A1
(43) Pub. Date: Nov. 21, 2002

(54) Ink jet system image forming device and waste ink tube cleaning method

(76) Inventors: Kazutaka Miyamoto, Tokyo (JP); Chihiro Maruyama, Tokyo (JP)

Correspondence Address: DELLETT AND WALTERS, 310 S.W. FOURTH AVENUE, SUITE 1101, PORTLAND, OR, 97204, US

(21) Appl. No.: 10/129,228

(22) PCT Filed: Dec. 15, 2000
(86) PCT No.: PCT/JP00/08907

(30) Foreign Application Priority Data
Dec. 17, 1999 (JP) 11/359518

(51) Int. Cl. B41J 2/165

(52) U.S. Cl. 347/30

(57) ABSTRACT

Ink (pigment component ink) is jetted toward an ink absorber (34K) from the nozzle (22K) only of a print head (20K), with no ink jetted from print heads (20C, 20M, 20Y). Next, a carriage (24) is moved in an arrow B′ direction to position the print head (20C) directly above a cap (32K), at that time ink (dye component ink) is jetted toward the ink absorber (34K) from the nozzle (22C) only of the print head (20C) to allow the dye component ink to flow into a waste ink tube (36K). Then, ink (dye component ink) is similarly jetted toward the ink absorber (34K) from the nozzle (22M) only of the print head (20M), whereby the pigment component ink is allowed to flow smoothly without clogging a waste ink tube with a stuck, solid pigment component ink.

### TECHNICAL FIELD

The present invention relates to an ink-jet image-forming apparatus which records an image by ejecting an ink from a printing head onto a recording medium. The present invention also relates to a method for cleaning a waste ink tube through which a waste ink sucked out or ejected from the printing head is allowed to flow.

### BACKGROUND TECHNIQUE

Ink-jet image-forming apparatuses are known as a kind of output apparatus of computers and work stations. The ink-jet image-forming apparatus forms an image by ejecting an ink on a recording medium like a paper sheet. An example of the ink-jet image-forming apparatus is explained by reference to FIGS. 5 and 6.

FIG. 5 is a perspective view of an ink-jet printer, an example of the ink-jet image-forming apparatus. FIG. 6 is a partially cutaway front view illustrating schematically a portion of the ink-jet printer shown in FIG. 5.

The ink-jet printer 10 has, as shown in FIG. 5, a control section 12 for controlling the printer 10. The control section 12 gives indications regarding the kind of recording paper, on-line/off-line, commands, and so forth by the switches. The ink-jet printer 10 has an opening 14 for inserting and discharging a recording medium. The recording medium is inserted through the opening 14 into the ink-jet printer, and there an image is printed on the recording medium. The recording medium after image printing is discharged through the opening 14 in the arrow A direction to a basket or a like receiver (not shown in the drawing). In the lower portion of the ink-jet printer 10, a waste ink tank 18 is provided for storing the waste ink as described below.

The ink-jet printer 10 has, as shown in FIG. 6, a printing head 20 which has nozzles 22K, 22C, 22M, 22Y (see FIG. 7) for ink ejection; a carriage 24 which carries the printing head and reciprocates in a main scanning direction (arrow B direction); and a driving roller 26 (see FIG. 5) which delivers the recording medium stepwise in a sub-scanning direction (arrow A direction) perpendicular to the main scanning direction.

The printing head 20 is constituted of a printing head 20K for ejecting a black ink, a printing head 20C for ejecting a cyan ink, a printing head 20M for ejecting a magenta ink, and a printing head 20Y for ejecting a yellow ink. The printing heads 20K, 20C, 20M, 20Y are connected respectively to ink tanks 26K, 26C, 26M, 26Y storing the color inks. The corresponding color inks are fed from the ink tanks 26K, 26C, 26M, 26Y to the respective printing heads 20K, 20M, 20C, 20Y.

For formation of an image on a recording paper sheet, the recording paper sheet delivered in the arrow A direction is temporarily stopped, and one printing band portion of the image is printed on an image formation zone of the recording paper sheet facing the outlets (ink ejection openings) of the nozzles 22K, 22C, 22M, 22Y by ejecting inks from the nozzles 22K, 22C, 22M, 22Y in accordance with image signals carrying an image information with the carriage 24 moved in reciprocation in the main scanning direction. Then, the recording paper sheet is delivered by one printing band width and stopped, and again another printing band portion of the image is printed on an adjacent image formation zone of the recording paper sheet by ejecting inks form the nozzles 22K, 22C, 22M, 22Y in accordance with image signals with the carriage 24 moved in reciprocation in the main scanning direction. Such operation is repeated to form the entire of the image on the recording paper sheet.

During continuous formation of images (or printing of letters) with inks by an image-forming apparatus like the above ink-jet printer 10, the ink ejection performance of the nozzles 22K, 22C, 22M, 22Y may decline to lower the image quality. The change of the ink ejection performance of the nozzles 22K, 22C, 22M, 22Y can be caused by formation of a bubble or entrainment of a foreign matter inside the nozzles 22K, 22M, 22C, 22Y.

For removal of the bubble or the foreign matter from the inside of the nozzle 22K, 22C, 22M, 22Y, an ink ejection recovery device 30 is employed which sucks forcibly the ink from the nozzles 22K, 22C, 22M, 22Y to recover the initial ink ejection performance. The ink ejection recovery device 30 is provided at one side end of the movement range of the carriage 24 outside the image formation zone as shown in FIG. 6. The ink ejection recovery device 30 is actuated on detecting some declination of the ink ejection performance, or at prescribed time intervals during the printing. To use the recovery device 30, the carriage 24 is moved above the recovery device 30, and the ink is sucked forcibly from each of the nozzles 22K, 22C, 22M, 22Y.

The ink ejection recovery device 30 is explained by reference to FIGS. 7, 8, and 9.

FIG. 7 shows schematically a state of forced suction of the ink from the respective nozzles. FIG. 8 shows schematically a state of ejection of ink from the respective nozzles. FIG. 9 shows schematically the recovery operation. In these drawings, the same symbols are used to indicate the same constitutional elements as those in FIG. 6.

The ink ejection recovery device 30 has rubber caps 32K, 32C, 32M, 32Y for capping the outlets of the nozzles 22K, 22C, 22M, 22Y, and has ink absorbents 34K, 34C, 34M, 34Y held respectively in the caps 32K, 32C, 32M, 32Y. Waste ink tubes 36K, 36C, 36M, 36Y are connected respectively to the caps 32K, 32C, 32M, 32Y. Beside the middle portion of each of the waste ink tubes 36K, 36C, 36M, 36Y, a rotary pump 38 and a pump cam 39 are provided to generate a negative pressure as shown in FIG. 9. FIG. 9 shows a waste ink tube 36K as an example. The other waste ink tubes 36C, 36M, 36Y have the same construction as the waste ink tube 36K.

In forced suction of the ink by means of the ink ejection recovery device 30, the outlets of the nozzles 22K, 22C, 22M, 22Y are capped (covered) respectively with the caps 32K, 32C, 32M, 32Y as shown in FIG. 7, and the inks are sucked by the negative pressure generated by the rotary pump 38 and the pump cam 39. Thereby a bubble or a foreign matter is sucked out together with the ink from the respective nozzles 22K, 22C, 22M, 22Y to clean the nozzles 22K, 22C, 22M, 22Y, and to restore the initial normal ejection performance of the respective nozzles 22K, 22C, 22M, 22Y. The ink (waste ink) sucked by the ink ejection recovery device 30 is introduced through the waste ink tubes 36K, 36C, 36M, 36Y to a waste ink tank 18 to be absorbed by ink absorbent 18a and stored therein.

For stabilization of the ink ejection performance of the nozzles 22K, 22C, 22M, 22Y, the inks may be preliminarily ejected from the nozzles 22K, 22C, 22M, 22Y. In this preliminary ejection, as shown in FIG. 8, the caps 32K, 32C, 32M, 32Y are placed below the outlets of the nozzles 22K, 22C, 22M, 22Y without capping the nozzles 32K, 32C, 32M, 32Y. In this state, the inks are ejected toward the ink absorbent 34K, 34C, 34M, 34Y to be absorbed thereby.

After the preliminary ejection, the inks are sucked from the ink absorbents 34K, 34C, 34M, 34Y by a negative pressure generated by the rotary pump 38 and the pump cam 39. The sucked inks are introduced through the waste ink tubes 36K, 36C, 36M, 36Y to the ink absorbent 18a in the waste ink tank 18 to be absorbed and stored therein.

For higher quality of the image formed on the recording medium with the aforementioned ink-jet printer 10, a pigment ink (black ink) which develops a strong color is stored in the ink tank 26K, and is ejected from the printing head 20, while dye inks which have transparency are stored in the ink tanks 26C, 26M, 26Y, and are ejected from the printing heads 20C, 20M, 20Y. Thereby, sharp black images can be formed with high contrast, whereas color images can be formed with sufficient gradation, high contrast, and natural color tone.

The pigment ink will become gel when the fluid such as water or ammonia contained in the ink is lost by drying. The trouble which can be caused by gelation is explained below by reference to FIG. 10.

FIG. 10(a) illustrates schematically the gel of the pigment ink formed in the waste ink tube, and FIG. 10(b) illustrates schematically a film of the pigment ink formed in the waste ink tube.

When the gel of the pigment ink is formed in the waste ink absorbent 34K or the waste ink tube 36K, the formed gel (sticking matter 40) is scattered in dots inside the ink absorbent 34K or on the inside wall of the waste ink tube 36K and sticks thereto. This sticking matter 40, which is nonfluidic, is not moved in the ink absorbent 34K or in the ink tube 36K by the suction by the negative pressure generated by the rotary pump 38 and the pump cam 39, or the like. Therefore, in the ink ejection recovery operation and preliminary ejection, this sticking matter 40 can hinder the ink flow and can prevent the sufficient suction of the ink from the nozzle 22K.

Further, the sticking matter 40 may form a film in the waste ink tube 36K to clog the ink flow path as shown in FIG. 10(b). In this state, if ink suction from the nozzle 22K is continued, serious trouble such as overflow of the ink from the waste ink tube 36K can be caused.

Such sticking will not occur under continuous running of the ink-jet printer 10. The sticking of the pigment ink is liable to occur after standing of the ink-jet printer 10, for example standing for several days without running, or on standing in the factory after assemblage and inspection before shipping. In the case where the ink-jet printer 10 is left standing before shipping, the ink-jet printer 10 may cause a trouble soon after beginning of use of the ink-jet printer 10. Such a trouble may cause a serious problem of fall of the commercial value of the ink-jet printer 10.

In the ink ejection recovery device 30, for generating the negative pressure by squeezing the waste ink tube 36K by the pump cam 39, the waste ink tube 36K is made of an elastic material like silicone. However, the material like rubber or silicone is less air-interceptive, so that the air can penetrate through the tube wall readily. Therefore, if the pigment ink is left in the waste ink tube 36K for a long term, water and other component of the pigment ink evaporates from the inside of the waste ink tube 36K to form the sticking matter 40 in the waste ink tube 36K.

The formation of the sticking matter 40 in the waste ink tube 36K as mentioned above prevents sufficient sucking of the ink from the nozzle 22K by the recovery device 30, resulting in low performance and short life of the printing head 20K, and lower quality of the image formed by the ink-jet printer 10.

### DISCLOSURE OF THE INVENTION

In the aforementioned circumstance, the present invention intends to provide an ink-jet image-forming apparatus which enables smooth flow of a pigment ink without clogging of the waste ink tube with a sticking matter formed from the pigment ink, and also to provide a method for cleaning the waste ink tube.

A first embodiment of the ink-jet image-forming apparatus, for achieving the above object, has a carriage which carries a pigment-printing head for ejecting a pigment ink and a dye-printing head for ejecting a dye ink, and reciprocates in a main scanning direction; and forms an image by ejecting the ink from the pigment-printing head and the dye-printing head onto a recording medium: the ink-jet image-forming apparatus comprising

(1) a waste pigment ink tube for flowing the ink sucked or ejected from the pigment printing head, and

(2) a controller for controlling the ink sucked or ejected from the dye printing head to flow through the waste pigment ink tube.

(3) The controller may control the pigment ink to flow firstly through the waste pigment ink tube and subsequently the dye ink to flow through the waste pigment ink tube.

(4) The controller may control the pigment ink to be ejected from the pigment-printing head and to flow through the waste pigment ink tube, and subsequently the dye ink to be ejected from the dye-printing head and to flow through the waste pigment ink tube.

(5) The ink-jet image-forming apparatus may have a pigment ink ejection recovery unit which sucks forcibly the pigment ink from the pigment-printing head and allows the pigment ink to the waste pigment ink tube, and

(6) the controller may control the pigment ink ejection recovery unit to suck forcibly the pigment ink from the pigment-printing head, and subsequently to suck forcibly the dye ink also from the dye-printing head.

The above ink-jet image-forming apparatus may comprise

(7-1) a pigment ink ejection recovery unit for sucking forcibly a pigment ink from the pigment-printing head and allowing the pigment ink to flow through the waste pigment ink tube,

(7-2) a dye ink ejection recovery unit for sucking forcibly a dye ink from the dye-printing head, and

(8) the controller selects the pigment ink ejection recovery unit or the dye ink ejection recovery unit to suck the dye ink forcibly from the dye-printing head.

(9) The ink-jet image-forming apparatus may have a cover for covering at least a part of the waste pigment ink tube.

A second embodiment of the ink-jet image-forming apparatus, for achieving the above object, has a carriage which carries a pigment-printing head for ejecting a pigment ink and a dye printing head for ejecting a dye ink and reciprocates in a main scanning direction; and forming an image by ejecting the ink from the pigment-printing head and the dye-printing head onto a recording medium: the ink-jet image-forming apparatus comprising

(10) a waste dye ink tube for flowing the ink sucked or ejected from the dye-printing head, and

(11) a controller for controlling the ink sucked or ejected from the pigment-printing head to flow through the waste dye ink tube.

(12) The controller may control the pigment ink to flow firstly through the waste dye ink tube and subsequently the dye ink to flow through the waste dye ink tube.

(13) The controller may control the pigment ink to be ejected from the pigment-printing head and to flow through the waste dye ink tube, and subsequently the dye ink to be ejected from the dye-printing head and to flow through the waste dye ink tube.

(14) The ink-jet image-forming apparatus may have a dye ink ejection recovery unit which sucks forcibly the pigment ink from the pigment-printing head and allows the pigment ink to flow through the waste dye ink tube, and

(15) the controller may control the dye ink ejection recovery unit to suck forcibly pigment ink from the pigment-printing head, and subsequently sucks forcibly the dye ink from the dye-printing head.

The ink-jet image-forming apparatus may comprise

(16-1) a pigment ink ejection recovery unit for sucking forcibly a pigment ink from the pigment-printing head and allowing the pigment ink to flow through the waste pigment ink tube, and

(16-2) a dye ink ejection recovery unit for sucking forcibly a dye ink from the dye-printing head, and

(17) the controller selects the pigment ink ejection recovery unit or the dye ink ejection recovery unit to suck the dye ink forcibly from the dye-printing head.

(18) The ink-jet image-forming apparatus may have a cover for covering at least a part of the waste dye ink tube.

A method is provided, for achieving the above object, for cleaning a waste ink tube for flowing a waste ink sucked or ejected from a pigment-printing head, in an ink-jet image-forming apparatus which has a carriage carrying a pigment-printing head for ejecting a pigment ink and a dye-printing head for ejecting a dye ink and reciprocating in a main scanning direction, and which forms an image by ejecting the ink from the pigment-printing head and the dye-printing head onto a recording medium, the method being conducted as follows:

(19) an ink is sucked or ejected from the pigment-printing head and is allowed to flow through the waste ink tube, -and subsequently

(20) an ink is sucked or ejected from the dye-printing head and is allowed to flow through the waste ink tube.

In this specification, the term “pigment ink” signifies an ink in which the coloring elementary particle is larger than a molecular size, and a fine particulate substance is dissolved in a medium like water. The term “dye ink” signifies an ink in which a molecular size material is dissolved in a medium like water.

### BRIEF DESCRIPTION OF THE DRAWINGS

FIG. 1 is a perspective view of an ink-jet printer, an example of the ink-jet image-forming apparatus of the present invention.

FIG. 2 is a drawing illustrating schematically a preliminary ejection operation of a pigment-printing head.

FIG. 3 a drawing illustrating schematically a preliminary ejection operation of a dye-printing head.

FIG. 4(a) is a perspective view of a pigment ink ejection recovery unit, and (b) is a perspective view of a part of a waste ink tube.

FIG. 5 is a perspective view of an ink-jet printer, an example of the ink-jet image-forming apparatus.

FIG. 6 is a partially cutaway front view showing schematically the inside of the ink-jet printer of FIG. 5.

FIG. 7 is a drawing illustrating schematically a state of forced sucking of ink from respective nozzles.

FIG. 8 is a drawing illustrating schematically a state of ejection of inks from respective nozzles.

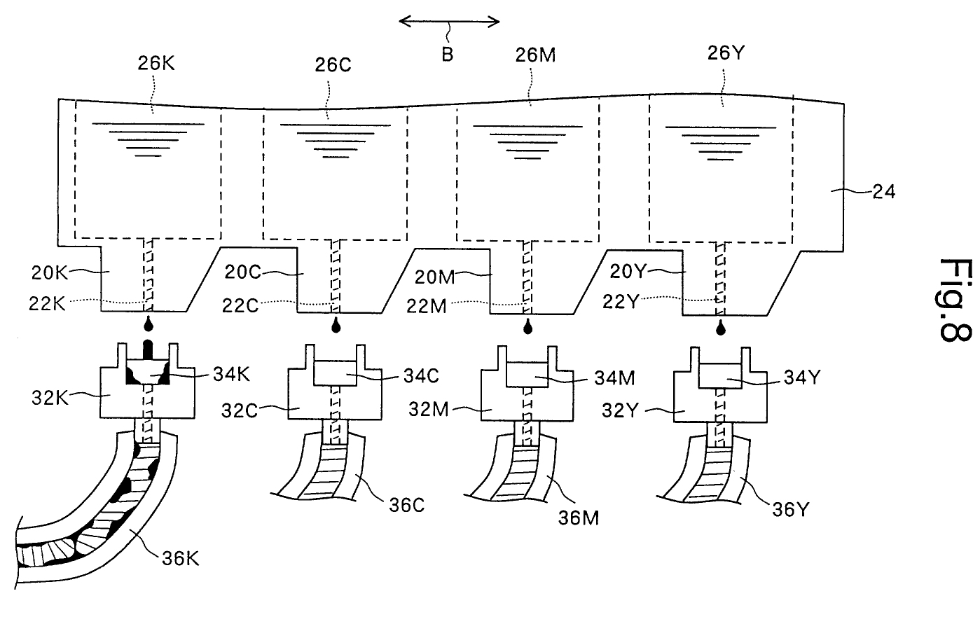

FIG. 9 is a drawing illustrating schematically a recovery operation with a conventional ink-jet image-forming apparatus.

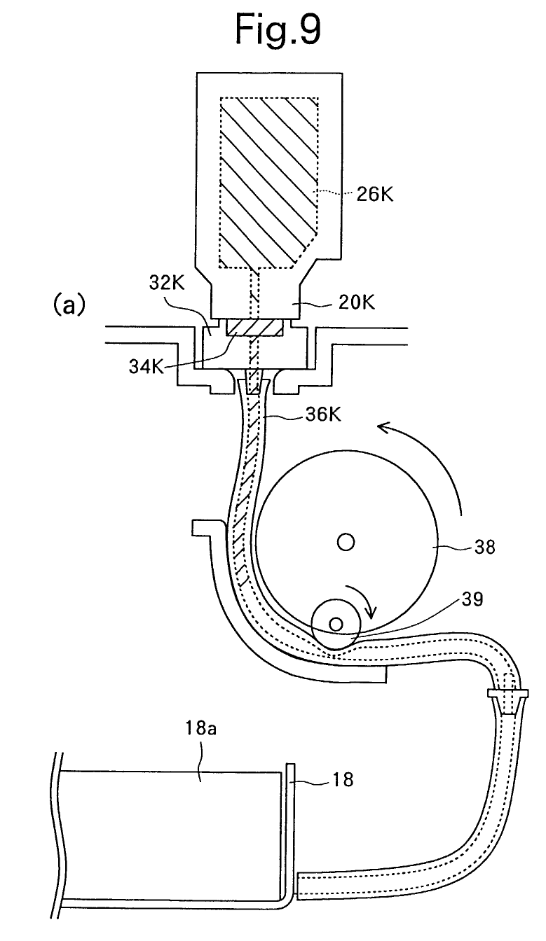

FIG. 10(a) is a drawing illustrating schematically formation of pigment ink gel in the waste ink tube, and (b) is a drawing illustrating a film formed from the pigment ink in the waste ink tube.

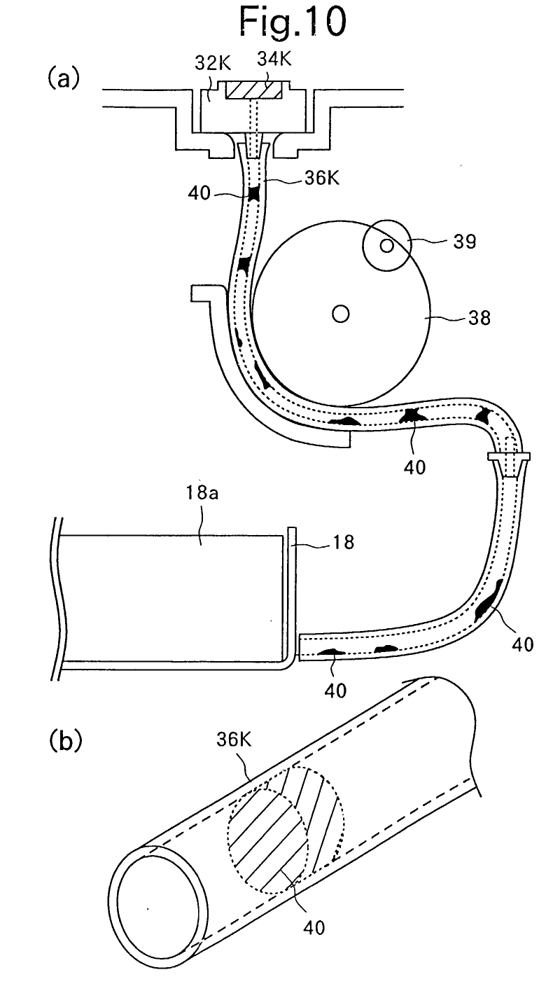

### BEST MODE FOR CARRYING OUT THE INVENTION

The mode for carrying out the present invention by reference to the drawings.

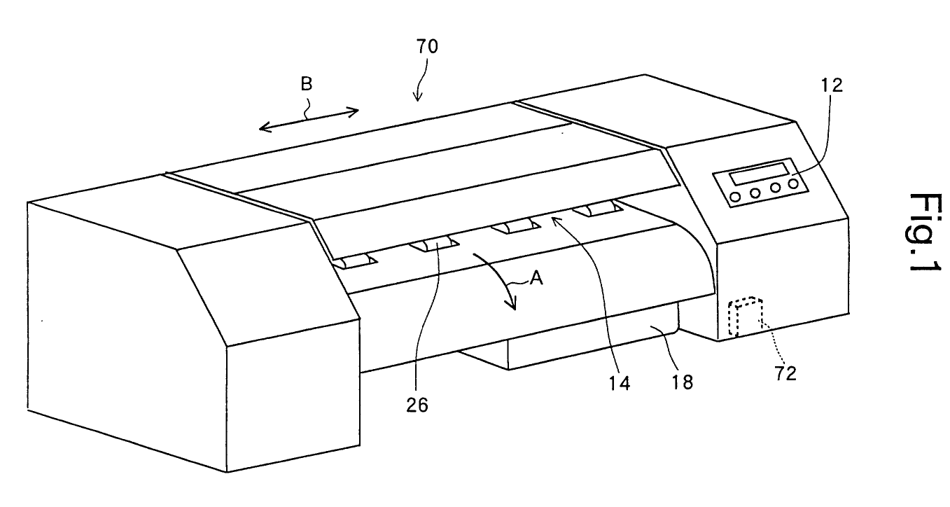

The preliminary ejection operation in the ink-jet image-forming apparatus of the present invention is explained by reference to FIG. 1 to FIG. 3.

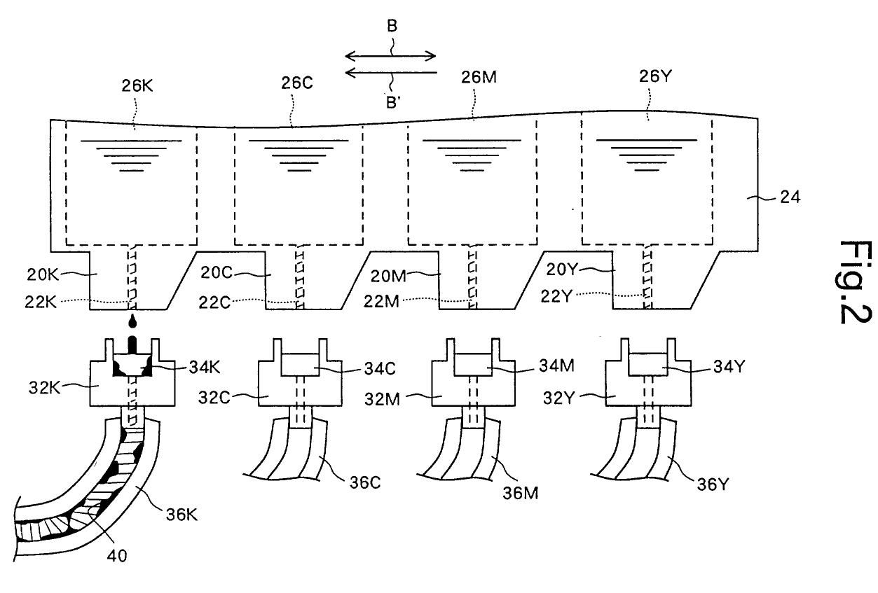

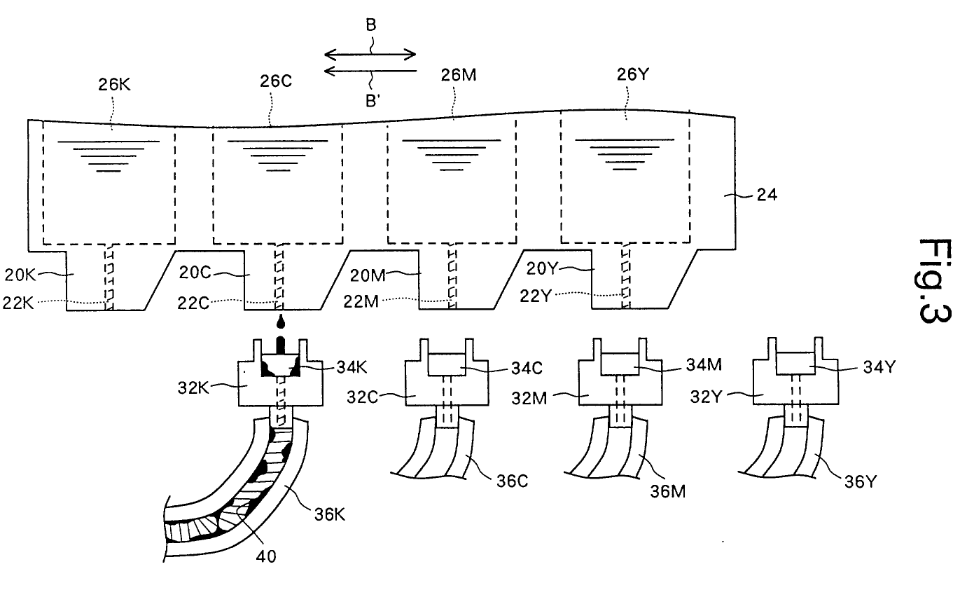

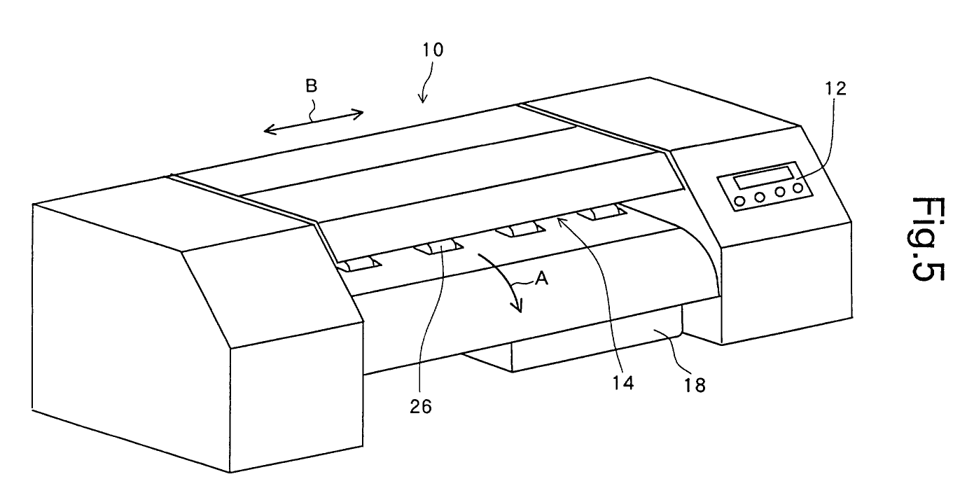

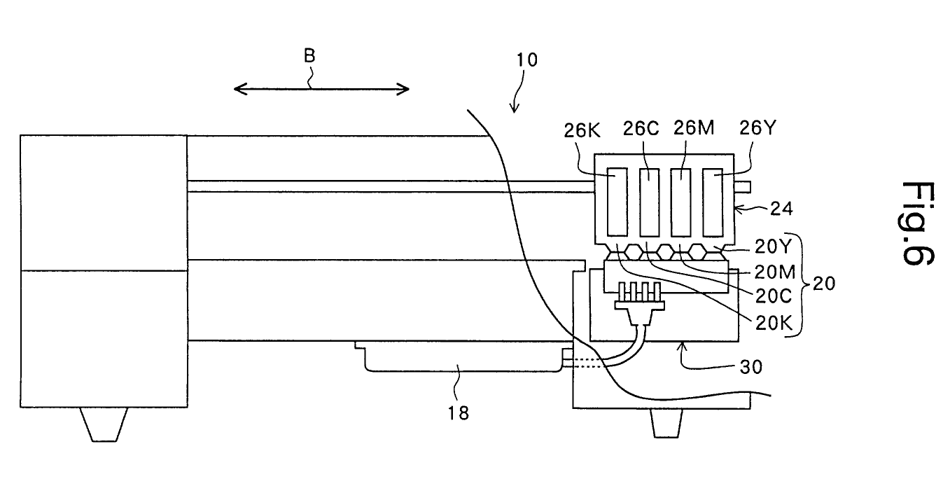

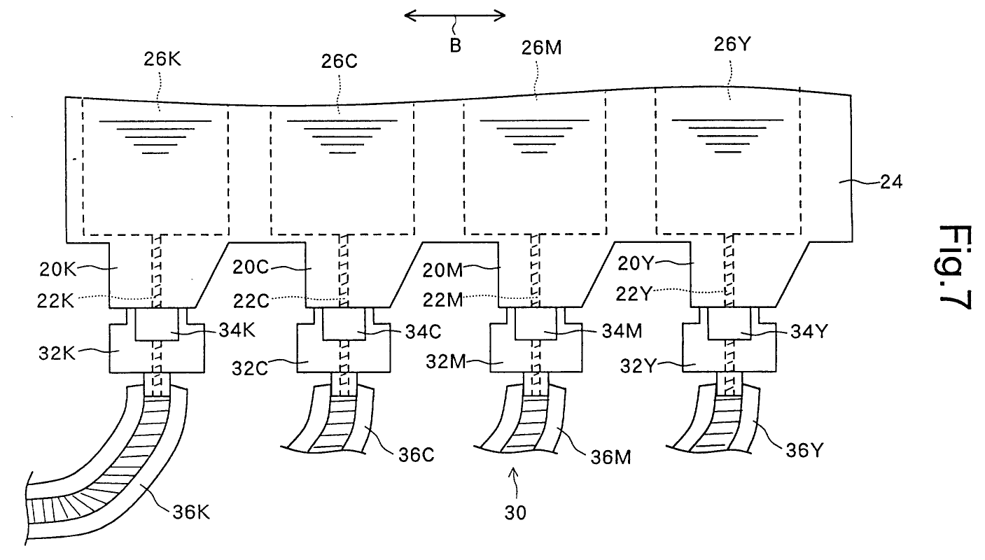

FIG. 1 is a perspective view of an ink-jet printer, an example of the ink-jet image-forming apparatus of the present invention. FIG. 2 illustrates schematically a preliminary ejection operation of a pigment-printing head. FIG. 3 illustrates schematically a preliminary ejection operation of a dye-printing head. In these drawings, the same constituting elements are indicated by the same symbols as the ones in FIG. 1 and FIG. 7. The ink-jet printer 70, which is an example of the ink-jet image-forming apparatus of the present invention, has nearly the same construction as that of conventional ink-jet printer 10 shown in FIG. 5 and FIG. 6 except that a controller 72 described later is incorporated in the ink-jet printer 70.

In the preliminary ejection operation or the ejection recovery operation with the ink-jet printer 70, the inks (examples of dye inks of the present invention) sucked or ejected from nozzles 22C, 22M, 22Y of the printing heads 20C, 20M, 20Y (examples of dye-printing heads in the present invention) are also allowed to flow through the waste ink tube 36K for the ink sucked or ejected from the nozzle 22K of the printing head 20K (an example of the pigment-printing head in the present invention). Such control that the inks ejected from all of the nozzles 22K, 22C, 22M, 22Y are allowed to flow through the waste ink tube 36K is conducted by the controller 72 by controlling the printing head 20K, 20C, 20M, 20Y and the carriage 24. This control is explained for the case of the preliminary ejection as the example. With a conventional ink-jet printer 10, in the preliminary ejection, inks are simultaneously ejected from the printing heads 20K, 20C, 20M, 20Y respectively onto the corresponding ink absorbents 34K, 34C, 34M, 34Y. On the contrary, with the ink-jet printer 70 of the present invention, firstly the ink (pigment ink) is ejected only from the nozzle 22K of the printing head 20K onto the ink absorbent 34K without ejecting the inks from the printing heads 20C, 20M, 20Y as shown in FIG. 2.

Then the carriage 24 is moved in the arrow B′ direction to bring the printing head 20C just above the cap 32K as shown in FIG. 3. In this state, the ink (dye ink) is ejected only from the nozzle 22C of the printing head 20C onto the ink absorbent 34K to allow the dye ink to flow through the waste ink tube 36K. Subsequently, the carriage 24 is further moved in the arrow B′ direction to bring the printing head 20M just above the cap 32K. In this state, the ink (dye ink) is ejected only from the nozzle 22M of the printing head 20M onto the ink absorbent 34K to allow the dye ink to flow through the waste ink tube 36K. Finally, the carriage 24 is further moved in the arrow B′ direction to bring the printing head 20Y just above the cap 32K. In this state, the ink (dye ink) is ejected only from the nozzle 22Y of the printing head 20Y onto the ink absorbent 34K. Thereby, the dye inks from the three printing heads 20C, 20M, 20Y are allowed to flow through the waste ink tube 36K.

Since the pigment ink does not have sufficient fluidity as described above, the pigment ink, when it dries, forms gel and stick to the inside wall of the waste ink tube 36K. On the contrary, the dye ink keeps its fluidity, even when it is dried. Accordingly, the pigment ink remaining in the waste ink tube 36K can be washed out by flowing the dye inks in an about three-fold amount immediately after the pigment ink has been allowed to flow. Thereby the gelation of the pigment ink by drying in the waste ink tube 36K can be prevented.

Even when the pigment ink forms gel and sticks to the inside wall of the waste ink tube 36K, the dye ink flowing through the waste ink tube 36K washes out the pigment ink gel to clean the waste ink tube 36K to enable smooth flow in the tube without clogging. This prevents overflow of the waste ink from the waste ink tube 36K or the like trouble caused by clogging with the pigment ink. As the result, the life of the printing head 20K can be lengthened without reducing the performance, and further the quality of the formed images is improved owing to the retained performance of the printing head 20K.

After the inks ejected preliminarily from all of the nozzles 22K, 22C, 22M, 22Y are allowed to flow through the waste ink tube 36K as described above, the rotary pump 38 and the pump cam 39 are driven (no-load suction) to generate a negative pressure. Thereby the dye ink absorbed in the absorbent 34K is released to wash out the ink from the waste ink tube 36K to clean the tube and to enable smooth flow of the ink. Incidentally, the combination of the cap 32K, the ink absorbent 34K, the rotary pump 38, the pump cam 39, and so forth is an example of the pigment ink ejection recovery unit in the present invention. The combinations of the caps 32C, 32M, 32Y, the ink absorbent 34C, 34M, 34Y, the rotary pump 38, the pump cam 39, and so forth are examples of the dye ink ejection recovery units in the present invention.

Next, another method of the preliminary ejection is explained below.

In this method, firstly, the ink (pigment ink) is ejected from only the nozzle 22K of the printing head 20K onto the ink absorbent 34K, and immediately thereafter no-load suction is conducted to produce a negative pressure to suck the pigment ink absorbed in the ink absorbent 34K. Successively, the inks (dye inks) are ejected from three nozzles 22C, 22M, 22Y onto the absorbent 34K, and immediately no-load suction is conducted. By this operation, the pigment ink remaining in the waste ink tube 36K after the first no-load suction is washed off by the subsequent no-load suction of the dye inks. By such a procedure of the preliminary ejection operation also, the gelation of the pigment ink by drying in the waste ink tube 36K is prevented similarly as in the operation mentioned before. In the above description, the preliminary ejection is explained as the example. The same procedure in the recovery operation also enables invariably the smooth ink flow in the waste ink tube 36K.

In the preliminary ejection mentioned above, the ink does not flow through the waste ink tubes 36C, 36M, 36Y. Therefore, the ink may be left remaining in the waste ink tube 36C, 36M, 36Y after the last preliminary ejection operation or recovery operation. However, the dye inks are not become gel on drying, not forming a solid sticking matter on the inside walls of waste ink tubes 36C, 36M, 36Y, and allowing smooth flow of the ink in the waste ink tubes 36C, 36M, 36Y.

In the aforementioned preliminary ejection operation or ejection recovery operation, the inks are ejected or sucked from all of the nozzles 22K, 22C, 22M, 22Y successively, and are allowed to flow through the waste ink tube 36K. Such operation takes longer time than the operation of simultaneous ejection or sucking from all of the nozzles 22K, 22C, 22M, 22Y and flowing the inks through the waste ink tubes 36K, 36C, 36M, 36Y. Therefore such operation is disadvantageous in view of the operation time.

However, the pigment ink gel formation by drying occurs after a certain long time Such a long time of standing of the ink-jet printer 70 is encountered, for example, in waiting for shipping after assemblage and inspection of the ink-jet printer 70 in the factory. This disadvantage in long-time standing can be canceled by setting the controller 72 to conduct the preliminary ejection or ejection recovery operation after inspection by printing. Thereby gelation of the pigment ink in the waste ink tube 36K during a long time of waiting for the shipping can be prevented.

Otherwise, the controller may be set to select the caps 32K, 32C, 32M, 32Y to select thereby suitably a washing mode and a normal recovery mode: the washing mode in which the printing heads 20C, 20M, 20Y are capped successively by the cap 32K and the ink ejection recovery operation is conducted; and the normal recovery mode in which the printing heads 20C, 20M, 20Y are capped respectively by the cap 32C, 32M, 32Y and the printing heads are subjected to ejection recovery simultaneously. Practice of the washing mode with such setting of the controller 72 prevents the drying and gelation of the pigment ink in the waste ink tube 36K, even in the case where the user does not use the ink-jet printer 70 for a long time by some reason.

In the above example, the pigment ink is allowed to flow through the waste ink tube 36K. Otherwise, the control is made by the controller 72 to allow the pigment ink to flow through any of the waste ink tubes 36C, 36M, 37Y, and to allow a dye ink to flow through the waste ink tube through which the pigment ink has been allowed to flow.

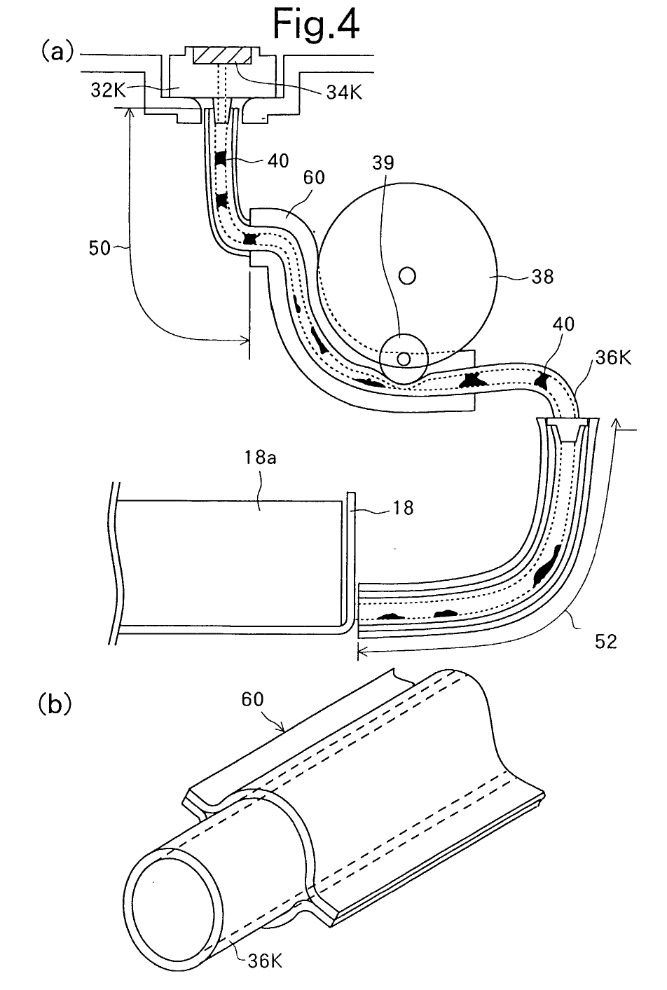

A technique of retarding the drying of the ink in the waste ink tube is explained by reference to FIG. 4.

FIG. 4(a) is a perspective view of a pigment ink ejection recovery unit, and (b) is a perspective view of a part of a waste ink tube.

Of the waste ink tube 36K connecting the cap 32K with the waste ink tank 18, the portions 50 and 52 shown in FIG. 4(a) are covered with a sheeting member 60 made of a metal such as aluminum (an example of the cover in the present invention). The portion of the waste ink tube 36K which is squeezed by the rotary pump 36 or the pump cam 39 is not covered with the sheeting member. The sheeting member 60 has a structure of two sheets holding-the waste ink tube 36K from the upside and the downside with the both ends thereof press-bonded as shown in FIG. 4(b). Otherwise the structure may be of a simple cylinder into which the waste ink tube 36K is inserted, or may be of a sheeting material which is wound spirally around the outside face of the waste ink tube 36K.

The covering of the waste ink tube 36K with the sheeting member 60 retards evaporation of water or a like matter from the pigment ink in the waste ink tube 36K even if the waste ink tube 36K is made of an air-permeable silicone or the like. The retardation of drying of the pigment ink prevents formation of sticking matter 40 of gel on the inside wall of the waste ink tube 36K.

Thereby, even when the pigment ink is remaining in the waste ink tube 36K, drying of the ink is retarded and the ink keeps its fluidity. Therefore, the remaining pigment ink is surely driven out by the flow of the pigment ink or of the dye ink in the usual ejection recovery operation (aforementioned normal recovery mode) or the aforementioned cleaning mode. Thereby, the clogging of the waste ink tube 36K by sticking of the pigment ink in the waste ink tube 36K is prevented.

### INDUSTRIAL AVAILABILITY

In the first embodiment of the ink-jet image-forming apparatus of the present invention, as described above, the waste pigment ink tube is cleaned by the flow of the dye ink to wash out any sticking ink gel in the waste pigment ink tube. Therefore, in the ink ejection recovery operation for recovering the initial state of ink ejection of the pigment-printing head, the ink ejected from the pigment-printing head flows smoothly through the waste pigment ink tube. This prevents overflow of the ink from the waste pigment ink tube or a like trouble caused by clogging with the pigment ink. Consequently, the life of the pigment printing head can be lengthened without lowering the performance thereof, and further the quality of the formed images is improved owing to the retained performance of the pigment printing head.

In the ink-jet image-forming apparatus, by setting the controller to allow the pigment ink to flow through the waste pigment ink tube and subsequently allow the dye ink to flow there, the dye ink washes out the pigment ink in the early stage to clean more completely the waste pigment ink tube.

In the ink-jet image-forming apparatus, by setting the controller to control the pigment ink to be ejected from a pigment-printing head to allow the pigment ink to flow through a waste pigment ink tube, and subsequently a dye ink to be ejected from a dye-printing head to flow through the waste pigment ink tube, the pigment ink is washed out by the dye ink to clean more completely the waste pigment ink tube.

The above ink-jet image-forming apparatus may comprise a pigment ink ejection recovery unit for sucking forcibly a pigment ink from the pigment-printing head and allowing the pigment ink to flow through the waste pigment ink tube, and a controller for controlling the pigment ink ejection recovery unit to suck the pigment ink forcibly from the pigment-printing head and subsequently to suck the dye ink forcibly from the dye-printing head. In this ink-jet image-forming apparatus, the waste pigment ink tube can be more completely cleaned by washing out the pigment ink by the dye ink.

The above ink-jet image-forming apparatus may comprise a pigment ink ejection recovery unit for sucking forcibly a pigment ink from the pigment-printing head and allowing the pigment ink to flow through the waste pigment ink tube, and a dye ink ejection recovery unit for sucking forcibly a dye ink from a dye-printing head; and the controller is set to employ selectively the pigment ink ejection recovery unit or the dye ink ejection recovery unit to suck the dye ink forcibly from the dye-printing head. This ink-jet image-forming apparatus is convenient for handling, since the inks can be sucked forcibly from one of the pigment-printing head and the dye-printing heads, or simultaneously from the pigment-printing head and the dye-printing heads.

The above ink-jet image-forming apparatus may comprise a cover for covering a part of the aforementioned waste pigment ink tube. This cover retards evaporation of water or a like matter from the waste pigment ink tube and prevents the pigment ink in the waste pigment ink tube from drying. Thereby, the pigment ink can be more surely washed off by the dye ink.

In the second embodiment of the ink-jet image-forming apparatus of the present invention, as described above, the waste dye ink tube is cleaned by the flow of the dye ink to wash out any sticking ink gel from the waste dye ink tube. Thereby, in the ink ejection recovery operation for recovering the initial state of ink ejection of the pigment-printing head, the ink ejected from the pigment-printing head flows smoothly through the waste dye ink tube. Consequently, overflow of the ink from the waste dye ink tube or a like trouble caused by clogging of the tube with the pigment ink can be prevented. As the result, the life of the pigment printing head can be lengthened without lowering the performance thereof, and further the quality of the formed images is improved owing to the retained performance of the pigment printing head. In the ink-jet image-forming apparatus, by setting the controller to allow the pigment ink to flow through the waste dye ink tube and subsequently allow the dye ink to flow there, the pigment ink is washed out by the dye ink in the early stage to clean more completely the waste dye ink tube.

In the ink-jet image-forming apparatus, by setting the controller to control the pigment ink to be ejected from a pigment-printing head, to allow the pigment ink to flow through the waste dye ink tube, and subsequently to control the dye ink to be ejected from the dye-printing head and to flow through the waste ink dye tube, the pigment ink is washed out by the dye ink to clean more completely the waste dye ink tube.

The above ink-jet image-forming apparatus may comprise a pigment ink ejection recovery unit for sucking forcibly the pigment ink from the pigment-printing head and allowing the pigment ink to flow through the waste dye ink tube, and a controller for controlling the pigment ink ejection recovery unit to suck the pigment ink forcibly from the pigment-printing head and subsequently to suck the dye ink forcibly from the dye-printing head. Thereby the waste dye ink tube can be more completely cleaned by washing out the pigment ink by the dye ink.

The above ink-jet image-forming apparatus may comprise a pigment ink ejection recovery unit for sucking forcibly a pigment ink from the pigment-printing head and allowing the pigment ink to flow through the waste pigment ink tube, a dye ink ejection recovery unit for sucking forcibly a dye ink from the dye-printing head, and a controller for selecting the pigment ink ejection recovery unit or the dye ink ejection recovery unit for sucking the dye ink forcibly from the dye-printing head. This the ink-jet image-forming apparatus is convenient for handling, since the inks can be sucked forcibly from one of the pigment-printing head and the dye-printing heads, or simultaneously from the pigment-printing head and the dye-printing heads.

The above ink-jet image-forming apparatus may comprise a cover for covering a part of the aforementioned waste dye ink tube. This cover retards evaporation of water or a like matter from the waste dye ink tube and prevent the pigment ink in the waste dye ink tube from drying. Therefore, the dye ink can be more surely washed off by the dye ink.

The waste ink tube cleaning method of the present invention washes out any sticking pigment ink gel from the waste ink tube with the dye ink flowing through the waste ink tube to clean more completely the waste ink tube. As the result, the waste ink flows smoothly through the waste ink tube without clogging by the waste ink.

1. An ink-jet image-forming apparatus which has a carriage carrying a pigment-printing head for ejecting a pigment ink and a dye-printing head for ejecting a dye ink and reciprocating in a main scanning direction, and which forms an image by ejecting the ink from the pigment-printing head and the dye-printing head onto a recording medium, wherein the ink-jet image-forming apparatus comprises
a waste pigment ink tube for flowing the ink sucked or ejected from the pigment printing head, and
a controller for controlling the ink sucked or ejected from the dye printing head to flow through the waste pigment ink tube.

2. The ink-jet image-forming apparatus according to claim 1, wherein the controller controls firstly the pigment ink to flow through the waste pigment ink tube and subsequently the dye ink to flow through the waste pigment ink tube.

3. The ink-jet image-forming apparatus according to claim 1, wherein the controller controls the pigment ink to be ejected from the pigment-printing head and to flow through the waste pigment ink tube, and subsequently the dye ink to be ejected from the dye-printing head and to flow through the waste pigment ink tube.

4. The ink-jet image-forming apparatus according to claim 1, wherein the ink-jet image-forming apparatus has a pigment ink ejection recovery unit which sucks forcibly the pigment ink from the pigment-printing head and allows the pigment ink to the waste pigment ink tube, and
the controller controls the pigment ink ejection recovery unit to suck forcibly the pigment ink from the pigment-printing head, and subsequently to suck forcibly the dye ink also from the dye-printing head.

5. The ink-jet image-forming apparatus according to claim 1, wherein the ink-jet image-forming apparatus comprises
a pigment ink ejection recovery unit for sucking forcibly a pigment ink from the pigment-printing head and allowing the pigment ink to flow through the waste pigment ink tube, and
a dye ink ejection recovery unit for sucking forcibly a dye ink from the dye-printing head; and
the controller selects the pigment ink ejection recovery unit or the dye ink ejection recovery unit to suck the dye ink forcibly from the dye-printing head.

6. The ink-jet image-forming apparatus according to any of claims 1 to 5, wherein the ink-jet image-forming apparatus has a cover for covering at least a part of the waste pigment ink tube.

7. An ink-jet image-forming apparatus which has a carriage carrying a pigment-printing head for ejecting a pigment ink and a dye-printing head for ejecting a dye ink, and reciprocating in a main scanning direction, and which forms an image by ejecting the ink from the pigment-printing head and the dye-printing head onto a recording medium, wherein the ink-jet image-forming apparatus comprises
a waste dye ink tube for flowing the ink sucked or ejected from the dye-printing head, and
a controller for controlling the ink sucked or ejected from the pigment-printing head to flow through the waste dye ink tube.

8. The ink-jet image-forming apparatus according to claim 7, wherein the controller controls the pigment ink to flow first through the waste dye ink tube and subsequently the dye ink to flow through the waste dye ink tube.

9. The ink-jet image-forming apparatus according to claim 7, wherein the controller controls the pigment ink to be ejected from the pigment-printing head and to flow through the waste dye ink tube, and subsequently the dye ink to be ejected from the dye-printing head and to flow through the waste dye ink tube.

10. The ink-jet image-forming apparatus according to claim 7, wherein the ink-jet image-forming apparatus has a pigment ink ejection recovery unit which sucks forcibly the pigment ink from the pigment-printing head and allows the pigment ink to flow through the waste dye ink tube, and
the controller controls the dye ink ejection recovery unit to suck forcibly the pigment ink from the pigment-printing head, and subsequently to suck forcibly the dye ink also from the dye-printing head.

11. The ink-jet image-forming apparatus according to claim 7, wherein the ink-jet image-forming apparatus comprises
a pigment ink ejection recovery unit for sucking forcibly a pigment ink from the pigment-printing head and allowing the pigment ink to flow through the waste pigment ink tube, and
a dye ink ejection recovery unit for sucking forcibly a dye ink from the dye-printing head; and
the controller selects the pigment ink ejection recovery unit or the dye ink ejection recovery unit to suck the dye ink forcibly from the dye-printing head.

12. The ink-jet image-forming apparatus according to any of claims 7 to 11, wherein the ink-jet image-forming apparatus has a cover for covering at least a part of the waste dye ink tube.

13. A method for cleaning a waste ink tube for flowing a waste ink sucked or ejected from a pigment-printing head, in an ink-jet image-forming apparatus which has a carriage carrying a pigment-printing head for ejecting a pigment ink and a dye printing head for ejecting a dye ink and reciprocating in a main scanning direction, and which forms an image by ejecting the ink from the pigment-printing head and the dye-printing head onto a recording medium, wherein
an ink is sucked or ejected from the pigment-printing head and is allowed to flow through the waste ink tube, and subsequently
an ink is sucked or ejected from the dye-printing head and is allowed to flow through the waste ink tube.
